(19) United States
(12) Patent Application Publication
(10) Pub. No.: US 2017/0109746 A1
(43) Pub. Date: Apr. 20, 2017

(54) METHOD AND SYSTEM FOR MANAGING PAYMENT TRANSACTIONS

(71) Applicant: MASTERCARD ASIA/PACIFIC PTE LTD, Singapore (SG)

(72) Inventors: Krishnadas MOHANDAS, Singapore (SG); Donghao HUANG, Singapore (SG); Akshita GOYAL, White Plains, NY (US); Yulia SURYA, Singapore (SG); Yong How CHIN, Singapore (SG)

(73) Assignee: MASTERCARD ASIA/PACIFIC PTE LTD, Singapore (SG)

(21) Appl. No.: 15/296,563

(22) Filed: Oct. 18, 2016

(30) Foreign Application Priority Data
Oct. 19, 2015 (SG) 10201508641V

(51) Int. Cl. G06Q 20/40; G06Q 20/10

(52) U.S. Cl. CPC G06Q 20/401; G06Q 20/102

(57) ABSTRACT

A method for managing payment transactions between a merchant and a payment-service-provider (PSP) using a payment management device in communication with a memory device. Each payment transaction is initiated by a consumer using a payment card. It involves (a) sending, to a PSP device associated with the PSP, a request for an authorization for a payment transaction; (b) receiving, from the PSP device, authorization for the payment transaction; (c) saving, in the memory device, data relating to the consumer and the payment transaction on a condition that the authorization for the payment transaction is received from the PSP device; (d) repeating steps (a), (b) and (c) for each of the plurality of payment transactions for a pre-determined period of time; and (e) aggregating the plurality of payment transactions into an aggregated payment transaction based on the data relating to the consumer and each of the plurality of payment transactions.

### TECHNICAL FIELD

The present disclosure relates broadly, but not exclusively, to methods and systems for managing a plurality of payment transactions between a merchant and a payment-service-provider (PSP).

### BACKGROUND

An acquiring bank (or acquirer) is a bank or financial institution that processes credit and/or debit card payments for products or services for a merchant. The term acquirer indicates that the bank accepts or acquires payment card transactions from merchants. The acquiring bank has a contract with the merchant, and creates a merchant account for the merchant. Under this agreement, the acquiring bank exchanges funds with issuing banks on behalf of the merchant, and pays the merchant for the net balance of their daily payment card activity: gross sales minus reversals, interchange fees, and acquirer fees.

As this arrangement includes a line of credit, the acquiring bank is accepting certain risks. For example, the acquiring bank accepts the risk that the merchant remains solvent over time. Thus, before an acquiring bank approves a merchant for processing payment card transactions, the acquiring bank usually requires the merchant to complete an extensive application process wherein the merchant is required to provide very detailed financial information so that the acquiring bank can review it before making its decision about whether to underwrite the merchant. The process of submitting and reviewing the merchant application is typically complicated and time consuming, and can discourage many smaller to mid-size merchants from trying to register for such services. Consequently, many smaller to mid-size merchants have had to forego transacting business using payment card transactions.

There are service provider companies, hereinafter referred to as payment-service-providers (PSPs), that seek to assist small or mid-size merchants that are unbanked (i.e. are not tied to an acquiring bank) by registering and underwriting the merchants with an acquiring bank in real-time for processing payment card transactions, and managing the payment card transactions for the merchant by providing transaction management services to the merchant. In this manner, these unbanked small or mid-size merchants are able to transact business using payment card transactions.

These PSPs usually charge a fee for their services. The fee typically consists of a base fee and an additional fee per transaction. Many PSPs charge a base fee of 2.9% of the transaction amount plus an additional 30 cents per transaction, for example.

For merchants that offer products with relatively low prices, the fees (in particular, the additional fee) can be quite significant compared to the price of the product. For example, a product that is sold for $5 will incur a PSP fee of about 44 cents. That is, the PSP fee is almost 9% of the price of the product. The merchant usually has to absorb the PSP fees and this eats into his profit margin. This done over a period of time results in substantial margin erosion. For example, ten such transactions result in a PSP fee of $4.40.

A need therefore exists to provide methods and systems for managing a plurality of payment transactions between a merchant and a payment-service-provider (PSP).

### SUMMARY

According to a first aspect, there is provided a method for managing a plurality of payment transactions between a merchant and a payment-service-provider (PSP) using a payment management device in communication with a memory device, wherein each payment transaction is initiated by a consumer using a payment card, the method comprising: (a) sending, to a PSP device associated with the PSP, a request for an authorization for a payment transaction; (b) receiving, from the PSP device, authorization for the payment transaction; (c) saving, in the memory device, data relating to the consumer and the payment transaction on a condition that the authorization for the payment transaction is received from the PSP device; (d) repeating steps (a), (b) and (c) for each of the plurality of payment transactions for a pre-determined period of time; and (e) after expiry of the pre-determined period of time, aggregating the plurality of payment transactions into an aggregated payment transaction based on the data relating to the consumer and each of the plurality of payment transactions, such that the aggregated payment transaction can be settled in lieu of each of the plurality of payment transactions.

In an embodiment, the method may further comprise transmitting, to the PSP device, data relating to the aggregated payment transaction for settlement.

In an embodiment, the method may further comprise receiving the request for the authorization for the payment transaction from a merchant device associated with the merchant, wherein the request is sent to the PSP device after receipt from the merchant device.

In an embodiment, the method may further comprise transmitting, to the merchant device, an authorization success signal on a condition that the authorization for the payment transaction is received from the PSP device.

In an embodiment, the method may further comprise receiving the data relating to the consumer and payment transaction from the merchant device for saving in the memory module.

In an embodiment, the data relating to the consumer may comprise at least one of: credentials of the consumer and identity data of the consumer. The identity data of the consumer may comprise a primary account number (PAN) of the consumer. The data relating to the payment transaction may comprise at least one of: transaction amount and identity data of the merchant involved in the payment transaction.

In an embodiment, the pre-determined period of time may be based on an authorization-hold period.

According to a second aspect, there is provided a system for managing a plurality of payment transactions between a merchant and a payment-service-provider (PSP), each payment transaction being initiated by a consumer using a payment card, wherein the system comprises a payment management device that comprises: at least one processor; and at least one memory including computer program code; the at least one memory and the computer program code configured to, with at least one processor, cause the predictor module at least to: (a) send, to a PSP device associated with the PSP, a request for an authorization for a payment transaction; (b) receive, from the PSP device, authorization for the payment transaction; (c) save, in the memory, data relating to the consumer and the payment transaction on a condition that the authorization for the payment transaction is received from the PSP device; (d) repeat steps (a), (b) and (c) for each of the plurality of payment transactions for a pre-determined period of time; and (e) after expiry of the pre-determined period of time, aggregate the plurality of payment transactions into an aggregated payment transaction based on the data relating to the consumer and each of the plurality of payment transactions, such that the aggregated payment transaction can be settled in lieu of each of the plurality of payment transactions.

In an embodiment, the predictor module may be further caused to transmit, to the PSP device, data relating to the aggregated payment transaction for settlement.

In an embodiment, the predictor module may be further caused to receive the request for the authorization for the payment transaction from a merchant device associated with the merchant, wherein the request is sent to the PSP device after receipt from the merchant device.

In an embodiment, the predictor module may be further caused to transmit, to the merchant device, an authorization success signal on a condition that the authorization for the payment transaction is received from the PSP device.

In an embodiment, the predictor module may be further caused to receive the data relating to the consumer and payment transaction from the merchant device for saving in the memory module.

In an embodiment, the data relating to the consumer may comprises at least one of: credentials of the consumer and identity data of the consumer. The identity data of the consumer may comprise a primary account number (PAN) of the consumer. The data relating to the payment transaction may comprise at least one of: transaction amount and identity data of the merchant involved in the payment transaction.

In an embodiment, the pre-determined period of time may be based on an authorization-hold period.

According to a third aspect, there is provided a non-transitory computer readable medium having stored thereon executable instructions for controlling a payment management device to perform steps comprising: (a) sending, to a PSP device associated with the PSP, a request for an authorization for a payment transaction; (b) receiving, from the PSP device, authorization for the payment transaction; (c) saving, in the memory device, data relating to the consumer and the payment transaction on a condition that the authorization for the payment transaction is received from the PSP device; (d) repeating steps (a), (b) and (c) for each of the plurality of payment transactions for a pre-determined period of time; and (e) after expiry of the pre-determined period of time, aggregating the plurality of payment transactions into an aggregated payment transaction based on the data relating to the consumer and each of the plurality of payment transactions, such that the aggregated payment transaction can be settled in lieu of each of the plurality of payment transactions.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a flow chart illustrating a method for managing a plurality of payment transactions between a merchant and a payment-service-provider (PSP) according to an example embodiment.

FIG. 2 shows a schematic diagram illustrating a process flow of a method for conducting payment transactions according to an example embodiment.

FIG. 3 shows a schematic of a system for managing a plurality of payment transactions between a merchant and a payment-service-provider (PSP).

FIG. 4 is a schematic of an example service system according to an example embodiment.

FIG. 5 shows an exemplary computing device suitable for executing the method for managing a plurality of payment transactions between a merchant and a payment-service-provider (PSP).

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

The following description is directed to methods and systems for managing payment transactions between a merchant and a payment-service-provider (PSP). In the following description, “merchant” refers to an unbanked merchant (i.e. not contracted to an acquiring bank). Such merchants are usually everyday small (home-business owners, “blogshop” owners, etc.) or mid-size merchants that find it difficult to use an acquiring bank's services for participation in payment card transactions. The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

In the following description, “payment-service-provider” (PSP) refers to a service provider company that seeks to assist merchants by registering and underwriting them with an acquiring bank in real-time for processing payment card transactions, and managing the payment card transactions for the merchant by providing transaction management services to the merchant. In this manner, these merchants need not be contracted to an acquiring bank but are able to transact business using payment card transactions. In other words, in the following description, a PSP is not considered an acquiring bank (in the traditional sense), but is an entity that acts as a middle-man between an acquiring bank and a merchant. Examples of PSP platforms are Simplify Commerce™ by Mastercard® and Stripe™.

These PSPs usually charge a fee for their services. The fee typically consists of a base fee and an additional fee per transaction. PSPs may charge a base fee of 2.9% of the transaction amount plus an additional 30 cents per transaction, for example. For merchants that offer products with relatively low prices, the fees (in particular, the additional fee) can be quite significant compared to the price of the product. For example, a product that is sold for $5 will incur a PSP fee of about 44 cents. That is, the PSP fee is almost 9% of the price of the product. The merchant usually has to absorb the PSP fees and this eats into his profit margin.

Currently, many merchants that use the PSP's services have multiple transactions, at times from the same payment cardholder, and within a short period of time. For example, a “blogshop” owner may offer tee-shirts at $5 each. A particular consumer (i.e. payment cardholder) may purchase four tee-shirts from the blogshop within a span of a week. Each tee-shirt may have been purchased through a separate payment transaction (i.e. four payment transactions). Based on the current PSP fee structure by Simplify Commerce™, the merchant incurs 44 cents per payment transaction. A total of four payment transactions incur about $1.78 in PSP fees, which is almost 9% of the total price of the product.

Accordingly, the methods and systems described herein seek to reduce the PSP fees incurred by merchants, especially merchants that offer products with relatively low prices and whose customers make multiple purchases within a relatively short span of time (e.g. one week) through separate payment transactions. In an exemplary embodiment, multiple payment transactions conducted between the same payment cardholder and a particular merchant within a pre-defined period are processed in batches (i.e. processed in aggregate). An “authorization hold” is done on the payment card while performing each transaction, and the transaction details are held along with the cardholder's credentials (typically in the form of a token). These multiple transactions are processed upon expiry of the pre-defined period (i.e. the authorization hold period, which may be between 5 to 7 days) or when there are a sufficient number of transactions done per payment card. A payment management entity that manages and aggregates the multiple payment transactions acts as a middle-man between the merchants and the PSP.

In this context, an “authorization hold” (also known as “preauthorization” or “preauth”) is the practice of authorizing electronic transactions done with a payment card and holding this balance as unavailable either until the merchant clears the transaction, or the hold “falls off”. In the case of debit cards, authorization holds can “fall off” the account anywhere from 1 to 8 business days after the transaction date depending on an issuing bank's policy. In the case of credit cards, authorization holds may last as long as 30 days, depending on the issuing bank. In an embodiment, the pre-defined period may be based on the authorization hold period determined by the issuing bank.

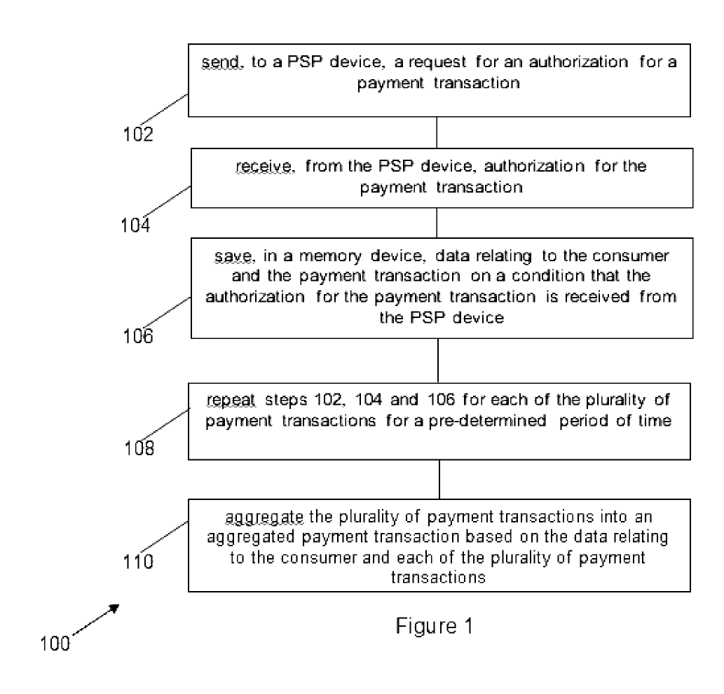

FIG. 1 is a flow chart illustrating a method 100 for managing a plurality of payment transactions between a merchant and a payment-service-provider (PSP) using a payment management device that is in communication with a memory device. Each payment transaction is initiated by a consumer (i.e. payment cardholder) using a payment card. In an exemplary implementation, the method involves the following steps.

At a first step 102, the payment management device sends, to a PSP device that is associated with the PSP, a request for an authorization for a payment transaction. The PSP device is in communication with the payment management device. When the PSP device receives the request for authorization for the payment transaction, the PSP device may check with an issuer (i.e. a financial institution, bank, credit union or company that issues or helps issue cards to payment cardholders) whether there are valid credit/funds available to the cardholder. If valid credit/funds are available, the issuer notifies the PSP (e.g. using an issuer device to send an authorization code to the PSP device) that the transaction can be authorized.

If valid credit/funds are available, at a second step 104, the payment management device receives, from the PSP device, authorization for the payment transaction. If there are insufficient credit/funds, the payment transaction is declined.

The request for the authorization for the payment transaction may be first received by the payment management device from a merchant device that is associated with the merchant. The merchant device (e.g. a point-of-sale (POS) terminal) is in communication with the payment management device. After the receipt of the authorization request by the payment management device, the payment management device sends/relays the authorization request to the PSP device as per step 102.

In an embodiment, if the authorization for the payment transaction is received from the PSP device by the payment management device (i.e. at step 104), the payment management device may be configured to transmit, to the merchant device, an authorization success signal. If the merchant can release the purchased product to the consumer upon receipt of the authorization success signal at the merchant device.

A third step, step 106, involves saving/storing, in the memory device, both data relating to the consumer and data relating to the payment transaction on a condition that the authorization for the payment transaction is received from the PSP device. In an embodiment, the payment management device is configured to receive the data relating to the consumer and payment transaction from the merchant device, and this information is saved/stored in the memory device. If the authorization for the payment transaction is not received from the PSP device, the data relating to the consumer and payment transaction is not saved/stored in the memory device.

The data relating to the consumer may include at least one of: credentials of the consumer (e.g. in the form of a token) and identity data of the consumer. The token/credentials may include card details that are used to settle payments. The token/credentials may be provided by the merchant through a device (e.g. a mobile phone, tablet computer, a POS terminal) that is connected to the Internet or via a webpage. The identity data of the consumer comprises a primary account number (PAN) of the consumer. For example, the PAN may be the numbers indicated on the consumer's credit card. The identity data of the consumer is used to uniquely identify the consumer and/or his account.

The data relating to the payment transaction comprises at least one of: transaction amount and identity data of the merchant involved in the payment transaction. The identity data of the merchant is used to uniquely identify the merchant.

The first, second and third steps (steps 102, 104 and 106, respectively) are repeated for each of the plurality of payment transactions for a pre-determined period of time. This repetition of steps is designated as step 108 in FIG. 1. In an embodiment, the pre-defined period may be based on the authorization-hold period determined, e.g. by the issuing bank.

After expiry of the pre-determined period of time, step 110 is initiated, which involves aggregating the plurality of payment transactions into a single aggregated/consolidated payment transaction based on the saved/stored data relating to the consumer and each of the plurality of payment transactions. The single aggregated payment transaction can be settled in lieu of each of the plurality of payment transactions. In particular, settlement may be performed in two phases/steps: (i) after expiry of the pre-determined period of time, settlement between the PSP and an intermediary entity; and thereafter (ii) settlement between the merchant and the intermediary entity. That is, essentially, the intermediary entity processes transactions “on behalf” of the merchant with the PSP. The intermediary entity acts as a middle-man between merchants and the PSP and administers the payment management device for aggregation/consolidation of the plurality of payment transactions into a single payment transaction. As the PAN of the consumer may be captured, the aggregation/consolidation of the plurality of payment transactions into a single payment transaction can be considered a PAN-based aggregation/consolidation of payment transactions.

In an embodiment, after aggregating the plurality of payment transactions into a single aggregated/consolidated payment transaction at step 110, data relating to the aggregated payment transaction is transmitted to the PSP device for settlement. As mentioned above, settlement may be performed in two steps: (i) settlement between the PSP and the intermediary entity; and thereafter (ii) settlement between the merchant and the intermediary entity.

In this manner, the PSP fee incurred by the merchant is advantageously lower compared to the traditional PSP fee structure. Using the example cited above where four tee-shirts were purchased from the blogshop through four separate transactions within a span of a week, a PSP fee of about 88 cents (i.e. ($20×2.9%)+30 cents) is incurred instead of about $1.78 in “traditional-PSP” fees. In this example, the total PSP fee that is incurred using embodiments of the invention are about half of the “traditional-PSP” fees. This is because the additional PSP fee is charged based on the single aggregated/consolidated payment transaction rather than four separate payment transactions. Here, it is assumed that the cardholder used the same payment-card (i.e. the same PAN is used).

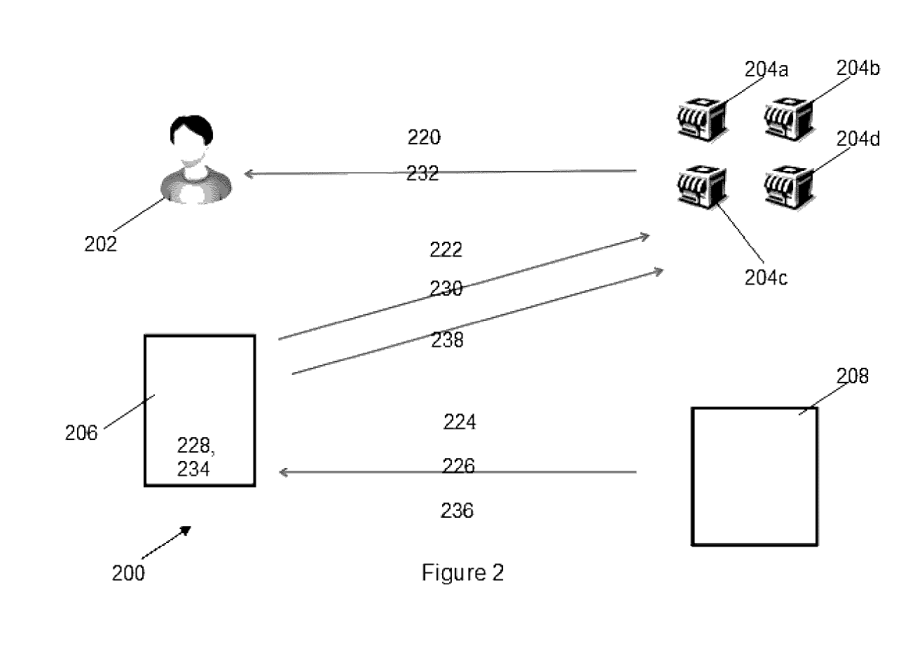

FIG. 2 shows a schematic diagram illustrating a process flow 200 of a method for conducting payment transactions according to an example embodiment. In particular, there is provided a platform wherein multiple payment transactions that are conducted between a single consumer 202 (i.e. a cardholder using a payment-card with a particular PAN) and a particular merchant (e.g. 204a) within a pre-defined period are processed in batches (i.e. processed in aggregate).

The consumer 202 wishes to purchase 220 items from one (e.g. 204a) of a plurality of merchants (204a, 204b, 204c, . . . , 204d). Embodiments advantageously allow more than one merchant to use the platform. Merchants who wish to use the platform may need to register/enrol themselves with an intermediary entity 206. The intermediary entity 206 acts as a middle-man between the merchants and the PSP and administers the platform that executes the aggregation/consolidation of the plurality of payment transactions into a single payment transaction. For the sake of brevity, only one merchant 204a is considered in the following description of the process flow 200.

The merchant 204a obtains the consumer's 202 payment card details and sends 222 data relating to the consumer 202 and data relating to the payment transaction (e.g. using a merchant device such as a point-of-sale (POS) terminal) to the intermediary entity 206. The intermediary entity 206 administers a payment management device that is configured to receive the consumer's 202 payment card details. The data relating to the consumer may include at least one of: credentials of the consumer (e.g. in the form of a token) and identity data (e.g. PAN) of the consumer. The identity data of the consumer is used to uniquely identify the consumer. The data relating to the payment transaction comprises at least one of: transaction amount and identity data of the merchant involved in the payment transaction. The identity data of the merchant is used to uniquely identify the merchant.

The payment management device is configured to send 224 a request for an authorization for the payment transaction to a PSP device that is associated with a PSP 208. When the PSP device receives the request for authorization for the payment transaction, the PSP device checks with an issuer (not shown in FIG. 2) whether there are valid credit/funds available to the consumer 202. If valid credit/funds are available, the issuer notifies the PSP 208 (e.g. using an issuer device to send an authorization code to the PSP device) that the transaction can be authorized. The PSP 208 then transmits 226 an authorization signal to the payment management device of the intermediary entity 206. Upon receipt of the authorization signal, the payment management device saves 228 the data relating to the consumer 202 and also the data relating to the payment transaction.

The intermediary entity 206 then relays the authorization of the transaction to the merchant 204a by using the payment management device to transmit 230 an authorization success signal to the merchant device. Upon receipt of the authorization success signal, the merchant 204a releases/delivers 232 the product to the consumer 202.

The foregoing process flows designated by reference numerals 220, 222, 224, 226, 228, 230 and 232 are repeated for each transaction that is initiated by the consumer 202 within a pre-determined period of time. Therefore, if the consumer 202 initiates six transactions within the pre-determined period of time, process flows designated by reference numerals 220, 222, 224, 226, 228, 230 and 232 are repeated six times.

Upon expiry of the pre-determined period of time, the payment management device is configured to aggregate 234 the plurality of payment transactions into an aggregated payment transaction based on the saved data relating to the consumer and each of the plurality of payment transactions. In particular, if there is more than one merchant (each with a unique merchant identity), the payment transactions can be aggregated on a merchant basis. That is, each aggregated payment transaction is related to a particular cardholder and a particular merchant. If, within the pre-determined period of time, the cardholder transacts with two different merchants, there are two aggregated payment transactions, one for each merchant.

The payment management device transmits 236 data relating to the aggregated payment transaction to the PSP device so that the aggregated payment transaction can be settled in lieu of each of the plurality of payment transactions. Settlement may be performed in two steps: (i) at the end of the pre-determined period of time (e.g. authorization-hold period), settlement between the PSP 208 and the intermediary entity 206; and thereafter (ii) settlement between the merchant 204a and the intermediary entity 206. That is, essentially, the intermediary entity 206 processes transactions “on behalf” of the merchants (e.g. 204a) with the PSP 208. If the cardholder transacts with two different merchants (merchant ABC and merchant XYZ) within the pre-determined period of time, a first aggregated payment transaction that is related to merchant ABC is eventually processed by the intermediary entity 206 “on behalf” of merchant ABC with the PSP 208; and a second aggregated payment transaction that is related to merchant XYZ is eventually processed by the intermediary entity 206 “on behalf” of merchant XYZ and the PSP 208.

In the event that upon expiry of the pre-determined period of time, there is only one transaction, the aggregation process may be skipped and the data relating to the sole transaction can be used for settlement. In such a case, the merchant does not experience any savings on the PSP fees.

In the event that before expiry of the pre-determined period of time, a number of transactions saved (i.e. process 228) exceeds a pre-defined limit, the payment management device may be configured to flush these transactions and aggregate these transactions into an aggregated transaction. In other words, each aggregated transaction can have a limited number of constituent transactions.

After the aggregated payment transaction can be settled between (i) the PSP 208 and the intermediary entity 206; and thereafter (ii) between the merchant 204a and the intermediary entity 206, the PSP 208 can charge the consumer 202 (via the issuer) for his purchases. The PSP 208 can also release 238 the relevant funds to the merchant 204a. For example, a fund-transfer-service (such as MoneySend™ by Mastercard®) can be used to release the relevant funds to the merchant 204a.

The relevant funds released to the merchant 204a can be the total cost of the products sold by the merchant to the consumer, less the PSP fees. In this case, there are no savings for the merchant in terms of the base fee. However, the merchant saves on the additional fees as the additional PSP fees are calculated based on the number of transactions. Since there is only one transaction (i.e. the aggregated transaction), the merchant only pays additional fees for one transaction rather than multiple transactions.

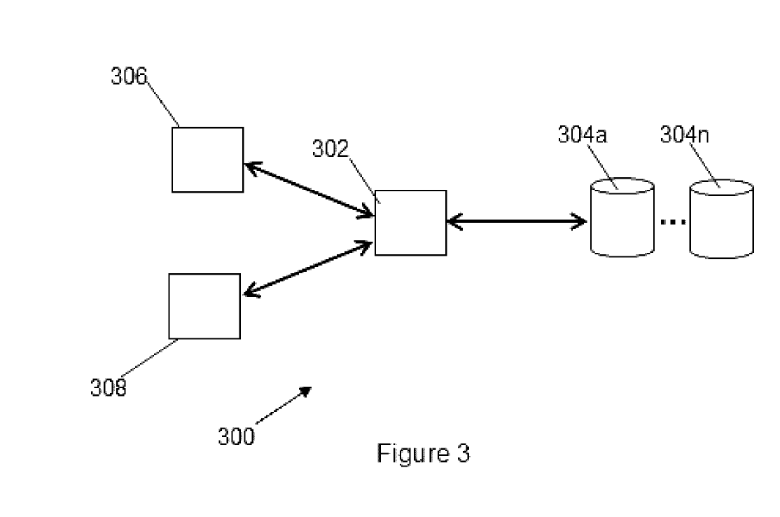

FIG. 3 shows a schematic of a network-based system 300 for managing a plurality of payment transactions between a merchant and a payment-service-provider (PSP). The system 300 comprises a purpose-built computing device in the form of a payment management device 302, one or more databases 304a . . . 304n, a merchant device 306 and a PSP device 308. Each of the one or more databases 304a . . . 304n are communicatively coupled with the payment management device 302. The payment management device 302, merchant device 306 and PSP device 308 may have appropriate communication modules for wired/wireless communication with each other via existing communication protocols. The databases 304a . . . 304n may be realized using cloud computing storage modules and/or dedicated servers communicatively coupled with the payment management device 302.

The payment management device 302 may comprise: at least one processor; and at least one memory including computer program code; the at least one memory and the computer program code configured to, with at least one processor, cause the payment management device 302 at least to: (A) send, to the PSP device 308 that is associated with the PSP, a request for an authorization for a payment transaction that is initiated by a consumer using a payment card; (B) receive, from the PSP device 308, authorization for the payment transaction; (C) save, in the at least one memory or in one of the databases 304a . . . 304n, data relating to the consumer and payment transaction on a condition that the authorization for the payment transaction is received from the PSP device 308; (D) repeat steps (A), (B) and (C) for each of the plurality of payment transactions for a pre-determined period of time; and (E) after expiry of the pre-determined period of time, aggregate the plurality of payment transactions into an aggregated payment transaction based on the data relating to the consumer and each of the plurality of payment transactions. The aggregated payment transaction can be settled in lieu of each of the plurality of payment transactions. The pre-determined period of time may be based on an authorization-hold period.

In an implementation, the payment management device 302 may be further caused to transmit, to the PSP device 308, data relating to the aggregated payment transaction for settlement. The payment management device 302 may also be further caused to transmit, to the merchant device 306, an authorization success signal on a condition that the authorization for the payment transaction is received from the PSP device 308.

In an implementation, the payment management device 302 may be further caused to receive the request for the authorization for the payment transaction from the merchant device 306, wherein the request is sent/relayed to the PSP device 308 after receipt from the merchant device 306. The payment management device 302 may also be further caused to receive the data relating to the consumer and payment transaction from the merchant device 306 for saving in the at least one internal memory or in one of the external databases 304a . . . 304n.

The data relating to the consumer may include at least one of: credentials of the consumer and identity data of the consumer. The identity data of the consumer may include a primary account number (PAN) of the consumer. The data relating to the payment transaction may include at least one of: transaction amount and identity data of the merchant involved in the payment transaction.

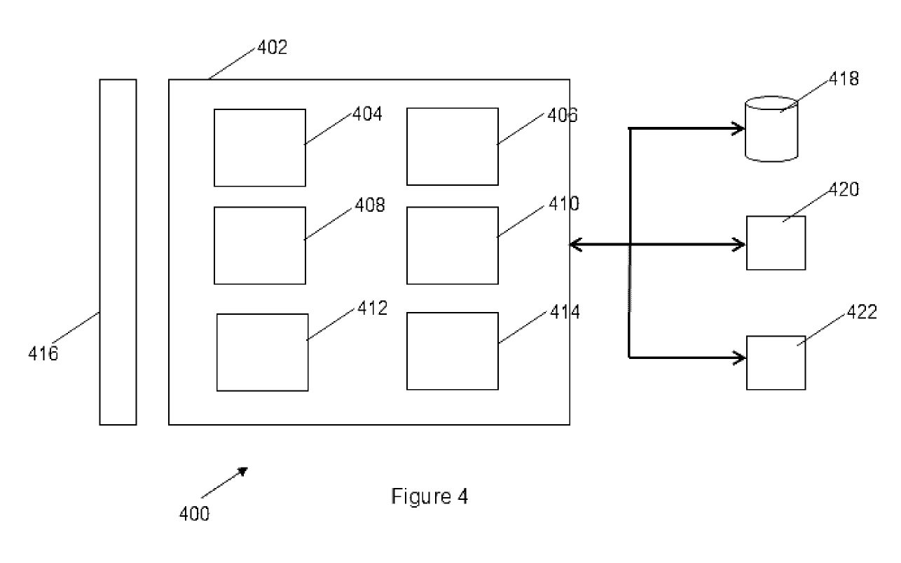

FIG. 4 is a schematic of an example service system 400 according to an example embodiment. The service system 400 can be used to perform one or more of the steps described herein for managing a plurality of payment transactions between a merchant and a PSP. The service system 400 comprises an application server 402 having a plurality of services, such as a control service 404, a merchant service 406, an aggregate service 408, a transaction service 410, a security service 412 and a user service 414. The application server 402 may be implemented using the computer system 500 described below. A web server 416 (e.g. Apache web server) can be used to store, process and deliver web pages to clients via Hypertext Transfer Protocol (HTTP) so that clients can access the various services of the application server 402. The service system 400 further comprises a database 418, a payment-service-provider (PSP) application program interface (API) 420 and a fund-transfer-service API 422. The database 418 can be used by any one of the services of the application server 402 to store relevant data.

The control service 404 is used to control the different services (i.e. merchant service 406, aggregate service 408, transaction service 410, security service 412 and user service 414) to perform common actions. For example, based on the situation, the control service 404 can be used to control the entire flow, end-to-end, to execute appropriate actions (e.g. calling user service 414 and merchant service 406 when needed to register a user or merchant, respectively). As another example, the control service 404 can be used when there is a complex business logic to transfer funds between a user, a merchant and a payment management entity (i.e. the intermediary entity that administers the application server 402).

The merchant service 406 can be used to insert, retrieve, update, and delete a merchant. The merchant service 406 can also be used to handle merchant registration, dashboard and sales reports.

The user service 414 can be used to create, retrieve and delete a user. The user service 414 can also be used to add a user contact list, notify a user via an email or push notification, ban a user or handle user log-ins for other businesses.

The aggregate service 408 can be used to start the aggregation of the plurality of transactions after expiry of the pre-determined period of time. When a time-based job scheduler (cron job) kick-starts the aggregation job, the aggregate service 408 is called to aggregate and consolidate the plurality of transactions before any fund transfer is started.

The transaction service 410 is used to insert, retrieve, update and delete transactions. The transaction service 410 can also be used to fire requests to the PSP API 420 and the fund-transfer-service API 422 to charge the consumer and transfer money to the merchant, respectively.

The security service 412 is used to handle authentication and authorization, data encryption before responses are sent to the client, and session management.

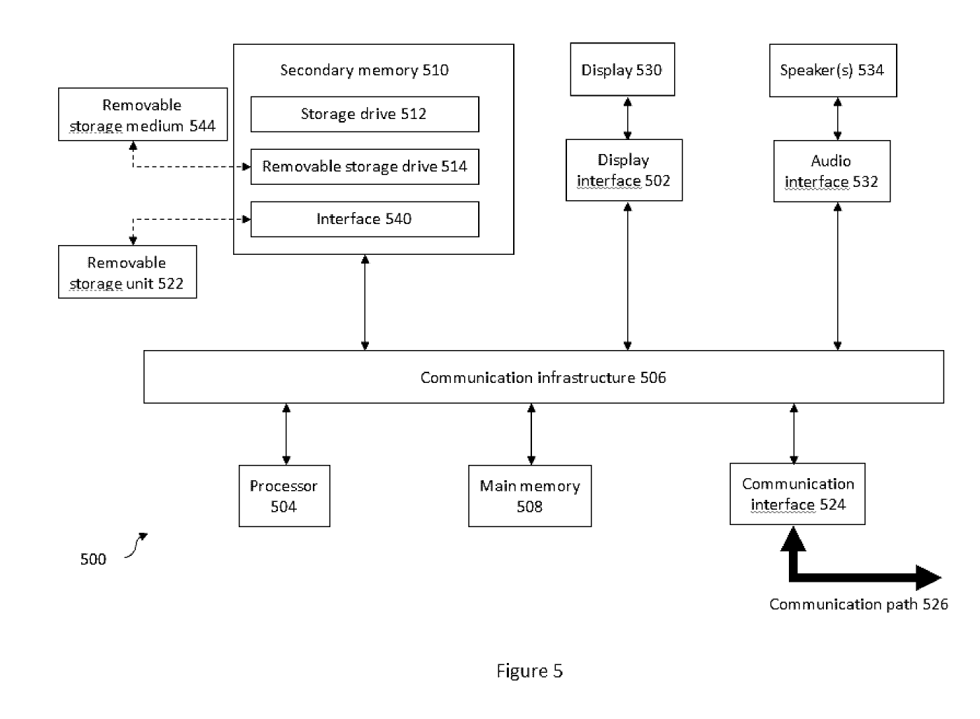

FIG. 5 depicts an exemplary computer/computing device 500, hereinafter interchangeably referred to as a computer system 500, where one or more such computing devices 500 may be used to facilitate execution of the above-described method for managing a plurality of payment transactions between a merchant and a payment-service-provider (PSP). In addition, one or more components of the computer system 500 may be used to realize the payment management device 302, PSP device 308 and/or application server 402. The following description of the computing device 500 is provided by way of example only and is not intended to be limiting.

As shown in FIG. 5, the example computing device 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 544 in a well-known manner. The removable storage medium 544 may include magnetic tape, optical disk, non-volatile memory storage medium, or the like, which is read by and written to by removable storage drive 514. As will be appreciated by persons skilled in the relevant art(s), the removable storage medium 544 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 540. Examples of a removable storage unit 522 and interface 540 include a removable memory chip (such as an EPROM or PROM) and associated socket, a removable solid state storage drive (such as a USB flash drive, a flash memory device, a solid state drive or a memory card), and other removable storage units 522 and interfaces 540 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the inventions, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port (such as a serial, parallel, printer, GPIB, IEEE 1394, RJ45, USB), an antenna with associated circuitry and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 544, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the storage drive 512, or the interface 540. Alternatively, the computer program product may be downloaded to the computer system 500 over the communications path 526. The software, when executed by the processor 504, causes the computing device 500 to perform functions of embodiments described herein.

In an embodiment, there is provided a non-transitory computer readable medium having stored thereon executable instructions for controlling a payment management device to perform steps comprising: (a) sending, to a PSP device associated with a PSP, a request for an authorization for a payment transaction that is initiated by a consumer; (b) receiving, from the PSP device, authorization for the payment transaction; (c) saving, in a memory device, data relating to the consumer and the payment transaction on a condition that the authorization for the payment transaction is received from the PSP device; (d) repeating steps (a), (b) and (c) for each of the plurality of payment transactions for a pre-determined period of time; and (e) after expiry of the pre-determined period of time, aggregating the plurality of payment transactions into an aggregated payment transaction based on the data relating to the consumer and each of the plurality of payment transactions. The aggregated payment transaction can be settled in lieu of each of the plurality of payment transactions.

It is to be understood that the embodiment of FIG. 5 is presented merely by way of example. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for managing a plurality of payment transactions between a merchant and a payment-service-provider (PSP) using a payment management device in communication with a memory device, wherein each payment transaction is initiated by a consumer using a payment card, the method comprising:
(a) sending, to a PSP device associated with the PSP, a request for an authorization for a payment transaction;
(b) receiving, from the PSP device, authorization for the payment transaction;
(c) saving, in the memory device, data relating to the consumer and the payment transaction on a condition that the authorization for the payment transaction is received from the PSP device;
(d) repeating steps (a), (b) and (c) for each of the plurality of payment transactions for a pre-determined period of time; and
(e) after expiry of the pre-determined period of time, aggregating the plurality of payment transactions into an aggregated payment transaction based on the data relating to the consumer and each of the plurality of payment transactions, such that the aggregated payment transaction can be settled in lieu of each of the plurality of payment transactions.

2. The method as claimed in claim 1, further comprising transmitting, to the PSP device, data relating to the aggregated payment transaction for settlement.

3. The method as claimed in claim 1, further comprising receiving the request for the authorization for the payment transaction from a merchant device associated with the merchant, wherein the request is sent to the PSP device after receipt from the merchant device.

4. The method as claimed in claim 3, further comprising transmitting, to the merchant device, an authorization success signal on a condition that the authorization for the payment transaction is received from the PSP device.

5. The method as claimed in claim 3, further comprising receiving the data relating to the consumer and payment transaction from the merchant device for saving in the memory module.

6. The method as claimed in claim 5, wherein the data relating to the consumer comprises at least one of: credentials of the consumer and identity data of the consumer.

7. The method as claimed in claim 6, wherein the identity data of the consumer comprises a primary account number (PAN) of the consumer.

8. The method as claimed in claim 5, wherein the data relating to the payment transaction comprises at least one of: transaction amount and identity data of the merchant involved in the payment transaction.

9. The method as claimed in claim 1, wherein the pre-determined period of time is based on an authorization-hold period.

10. A system for managing a plurality of payment transactions between a merchant and a payment-service-provider (PSP), each payment transaction being initiated by a consumer using a payment card, wherein the system comprises a payment management device that comprises:
at least one processor; and
at least one memory including computer program code;
the at least one memory and the computer program code configured to, with at least one processor, cause the predictor module at least to:
(a) send, to a PSP device associated with the PSP, a request for an authorization for a payment transaction;
(b) receive, from the PSP device, authorization for the payment transaction;
(c) save, in the memory, data relating to the consumer and the payment transaction on a condition that the authorization for the payment transaction is received from the PSP device;
(d) repeat steps (a), (b) and (c) for each of the plurality of payment transactions for a pre-determined period of time; and
(e) after expiry of the pre-determined period of time, aggregate the plurality of payment transactions into an aggregated payment transaction based on the data relating to the consumer and each of the plurality of payment transactions, such that the aggregated payment transaction can be settled in lieu of each of the plurality of payment transactions.

11. The system as claimed in claim 10, wherein the predictor module is further caused to transmit, to the PSP device, data relating to the aggregated payment transaction for settlement.

12. The system as claimed in claim 10, wherein the predictor module is further caused to receive the request for the authorization for the payment transaction from a merchant device associated with the merchant, wherein the request is sent to the PSP device after receipt from the merchant device.

13. The system as claimed in claim 12, wherein the predictor module is further caused to transmit, to the merchant device, an authorization success signal on a condition that the authorization for the payment transaction is received from the PSP device.

14. The system as claimed in claim 12, wherein the predictor module is further caused to receive the data relating to the consumer and payment transaction from the merchant device for saving in the memory module.

15. The system as claimed in claim 14, wherein the data relating to the consumer comprises at least one of: credentials of the consumer and identity data of the consumer.

16. The system as claimed in claim 15, wherein the identity data of the consumer comprises a primary account number (PAN) of the consumer.

17. The system as claimed in claim 14, wherein the data relating to the payment transaction comprises at least one of: transaction amount and identity data of the merchant involved in the payment transaction.

18. The system as claimed in claim 10, wherein the pre-determined period of time is based on an authorization-hold period.

19. A non-transitory computer readable medium having stored thereon executable instructions for controlling a payment management device to perform steps comprising:
(a) sending, to a PSP device associated with the PSP, a request for an authorization for a payment transaction;
(b) receiving, from the PSP device, authorization for the payment transaction;
(c) saving, in the memory device, data relating to the consumer and the payment transaction on a condition that the authorization for the payment transaction is received from the PSP device;
(d) repeating steps (a), (b) and (c) for each of the plurality of payment transactions for a pre-determined period of time; and
(e) after expiry of the pre-determined period of time, aggregating the plurality of payment transactions into an aggregated payment transaction based on the data relating to the consumer and each of the plurality of payment transactions, such that the aggregated payment transaction can be settled in lieu of each of the plurality of payment transactions.
